(19) United States
(12) Patent Application Publication
(10) Pub. No.: US 2008/0168876 A1
(43) Pub. Date: Jul. 17, 2008

(54) DEVICE FOR SUPPORTING PLATE-SHAPED MATERIALS

(75) Inventors: Friedrich Kilian, Leonberg/Gebersheim (DE); Martin Blaser, Vogt (DE)

Correspondence Address: FISH & RICHARDSON PC, P.O. BOX 1022, MINNEAPOLIS, MN, 55440-1022, US

(73) Assignee: TRUMPF WERKZEUGMASCHINEN GMBH + CO. KG, Ditzingen (DE)

(21) Appl. No.: 11/968,907

(22) Filed: Jan. 3, 2008

Related U.S. Application Data
(63) Continuation of application No. PCT/EP2006/006148, filed on Jun. 26, 2006.

(30) Foreign Application Priority Data
Jul. 6, 2005 (EP) 05014607.5

(51) Int. Cl. B65H 35/00; B65G 47/30; B65G 23/04; B65G 47/00

(52) U.S. Cl. 83/424; 198/597; 198/832; 198/617

(57) ABSTRACT

A device is provided for supporting plate-shaped materials for at least one separating operation in the plate-shaped material using a separating mechanism that is movable at least in the X direction during a separating operation. The device includes a first supporting table having a first supporting surface and a second supporting table having a second supporting surface. The supporting surface of the first supporting table and the supporting surface of the second supporting table are spaced apart from each other by a gap which is located below the separating mechanism. Each of the supporting tables comprises a separately driven belt conveyor which is guided by a plurality of rollers, each supporting surface being formed between at least two of the rollers which are spaced apart from each other and lie in a plane. The at least two rollers that bound the supporting surface are movable independently of each other in and counter to the Y direction.

### CROSS REFERENCE TO RELATED APPLICATIONS

This application is a continuation of and claims priority under 35 U.S.C. §120 to PCT Application No. PCT/EP2006/006148, filed on Jun. 26, 2006, which claimed priority to European Application No. 05014607.5, filed on Jul. 6, 2005. The contents of both of these priority applications are hereby incorporated by reference in their entirety.

### TECHNICAL FIELD

This invention relates to a device for supporting plate-shaped materials during at least one separating operation, e.g., during a cutting operation.

### BACKGROUND

JP 61206586 A discloses a device for supporting plate-shaped materials. During a separating operation in the plate-shaped material, a separating mechanism is moved in the X direction. The plate-shaped material is advanced in the Y direction, which runs transversely with respect to the X direction. This device comprises a first supporting table which has a first supporting surface, and a second supporting table which comprises a second supporting surface. A gap is formed between the first and second supporting surfaces of the supporting tables, and therefore a beam/jet of the separating mechanism may be guided through said gap. Each of the operating tables comprises a belt conveyor which is driven in each case by a motor. Each supporting surface is provided between two rollers, which lie in the plane of the supporting table. In order to position the plate-shaped material in the Y direction, grippers are additionally provided, the grippers being provided in order to convey the plate-shaped material. The gap between the two supporting surfaces is provided in a fixed position with respect to the supporting tables and to the separating mechanism. An analogous arrangement is known from GB 1 287 585.

These devices have the disadvantage that the position of the gap and also the gap width may not be changed. Furthermore, such a rigid system is unsuitable for connecting into an automatic process or requires cost-intensive additional modules for the loading and unloading of such a device with plate-shaped material.

WO 03/016004 has disclosed a supporting device for plate-shaped materials, which supporting device has a first and a second supporting surface for supporting a workpiece to be machined by a separating mechanism. A gap which separates the first supporting surface from the second supporting surface is provided below the separating mechanism. In order to position and set the gap, a link chain is provided, the respective free ends of which are clamped in a frame of the supporting device. The link chain extends from a clamping point on the device as far as a deflection pulley arranged on a carrying arm and forms the first supporting surface. The carrying arm is fixed to the device in the vicinity of the clamping point. The link chain is guided via a plurality of further deflection pulleys to a second deflection pulley arranged on a further carrying arm. From the second pulley arranged on the further carrying arm, the link chain leads, with a second supporting surface being formed, to a clamping of the device on the end side. Said supporting device has a single link chain which is clamped in each case on the end sides. Such a device is unsuitable for automatic handling, since it requires the separating mechanism to be shut down for a period for the loading and unloading of plate-shaped materials, in order to position the plate-shaped material on the supporting table or to remove it.

### SUMMARY

The present disclosure features devices for supporting plate-shaped materials for at least one separating operation in the plate-shaped material. The devices disclosed herein have great flexibility for the machining of the plate-shaped material and permit flexible connection into an automation process, in particular for loading and unloading of the plate-shaped materials.

In one aspect, the invention features a device for supporting plate-shaped materials for at least one separating operation in the plate-shaped material using a separating mechanism that is movable at least in the X direction during a separating operation. The device includes a first supporting table having a first supporting surface and a second supporting table having a second supporting surface. The supporting surface of the first supporting table and the supporting surface of the second supporting table are spaced apart from each other by a gap which is located below the separating mechanism. Each of the supporting tables comprises a separately driven belt conveyor which is guided by a plurality of rollers, each supporting surface being formed between at least two of the rollers which are spaced apart from each other and lie in a plane. The at least two rollers that bound the supporting surface are movable independently of each other in and counter to the Y direction.

This device has the advantage that, by means of the independent activation of the rollers which bound and determine the supporting surface, the position of the gap during the machining of the plate-shaped material in the operating region of the separating mechanism may be changed and also, independently thereof, the gap width may be varied. The changing of the gap width may be combined with a changing of the position of the gap, or vice versa. Furthermore, the supporting surface may be varied in size. In addition, the supporting surface of the supporting table can be transferred into a loading and unloading position irrespective of the positioning of the operating gap within an operating region of the device. This flexibility is made possible by means of the movable arrangement of the rollers which determine the size and position of the supporting surface, and also by means of supporting tables which each comprise separate belt conveyors.

In some implementations, the device further comprises at least one further roller which guides the belt conveyor and which is movable in one direction in space. This at least one further roller serves as a compensating roller in order to compensate for the change in the distance between the rollers which lie in a plane and determine the size of the supporting surface. This roller may be designed as a “dancing roller” or “jockey roller,” which is movable in a direction by being acted upon by force in order to apply a web tension to the belt conveyor.

In some implementations the at least one further roller is movable in a Z direction at right angles to the Y direction and/or in a Y direction in order to compensate for the size of the supporting surface. The direction of movement may be selected as a function of the available construction space. For example, particularly long supporting surfaces may be set by means of a compensating direction to the movement of the at least one further roller parallel to the plane of the supporting surface. Furthermore, this makes it possible for the supporting surface to be positioned in a loading and unloading station.

A roller of the first supporting table, which roller is assigned to the gap, and a roller of the second supporting table, which roller is assigned to the gap, are preferably movable relative to each other in order to set a gap width. As a result, different gap widths may be set for item parts as a function of machining parameters of the separating mechanism and also of the machining task. For example, the gap width for the ejection of material may be adapted as a function of the machining thickness of the plate-shaped material. Furthermore, the gap width for the unloading of the item parts and residual parts through the gap may be set and also for the transporting of them away via the supporting surface.

In some implementations a position of the gap formed between the first and second supporting tables may be changed within an operating region of the separating mechanism. This makes it possible to use a separating mechanism which is movable both in the X and in the Y direction, with the position of the gap being adjustable in the Y direction between the supporting surfaces and following the separating mechanism.

Preferably, in order to load or unload the plate-shaped material, a roller of the first or second supporting table, which roller is remote from the gap and is assigned to the supporting surface, is configured to be moved into a loading and unloading position. This makes it possible for, in particular, loading of an unmachined plate-shape material and/or unloading of a machined plate-shaped material to take place at the same time as another plate-shaped material is being machined in an operating region of the separating mechanism. By means of the enlarged supporting surface which goes beyond the operating region, a new plate-shaped material to be machined may be supplied or a machined, plate-shaped material removed, for example via a handling mechanism, such as a suction system.

In some implementations, the belt conveyors of the supporting tables are configured to be shut down during machining of the plate-shaped material, and the rollers of each supporting table which are assigned to the gap are configured to be moved synchronously in order to maintain a predetermined gap width, with the gap width migrating in the Y direction as a function of the position of the separating mechanism. In this case, the plate-shaped material remains in a rest position, and at the same time the gap migrates below the plate-shaped material to the current machining position of the separating mechanism. This may be combined at the same time with a change in the gap width.

In another implementation, during the machining of the plate-shaped material the belt conveyor is configured to be driven in a rotating manner, synchronously in or counter to the Y direction, such that the plate-shaped material is moved relative to the gap. In addition, the gap itself may be moved within the operating region.

In another implementation, the supporting surfaces are be formed by a multiplicity of individual belt conveyors arranged parallel to one another. Such a configuration has the advantage that a modular construction is utilized to obtain supporting surfaces of different width. These supporting surfaces, formed from a multiplicity of individual belt conveyors arranged parallel to one another, can be arranged at a distance from one another. As a result, gaps for machining may be formed not only in the X direction but also in the Y direction.

A further advantageous refinement of the supporting surface which comprises a multiplicity of individual belt conveyors which are arranged parallel to one another and are spaced apart from one another is provided by belt conveyors which are located in between and comprise a supporting surface which extends at least within the operating region of the separating mechanism. As a result, a holohedral supporting surface may be formed within the operating region of the separating mechanism.

Furthermore, the arrangement of the further individual belt conveyors makes it possible for them to be movable into a loading and unloading position. The individual belt conveyors can be spaced apart from one another, to allow loading and unloading devices which are of rake- or fork-shaped design to be positioned, for loading and unloading, in the clearances between the individual belt conveyors. This also makes it possible for existing systems to be retrofitted to utilize the devices disclosed herein.

In order to supply the plate-shaped material into and remove it from the operating region, it is preferably provided that at least one belt conveyor of the two operating tables is driven. A motor may be provided on a movable roller or on a positionally fixed roller which acts on the belt conveyor in order to drive it. By means of such a motor, an advancing movement is obtained in order to permit at least the loading and unloading function.

The invention also features methods of using the supporting devices disclosed herein during a separation process.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic side view of a supporting device with a first and a second supporting table, FIG. 2 shows a schematic side view of the device shown in FIG. 1 during the loading and unloading of the plate-shaped material.

FIG. 3 shows a schematic side view of the supporting device shown in FIG. 1 during loading and unloading with a supporting table positioned in a loading and unloading position.

FIG. 4 shows a schematic illustration of an exemplary operating step of the device as shown in FIG. 1.

FIGS. 5a and 5b show schematic side views of alternative embodiments of the supporting device.

FIG. 6a shows a schematic side view of an alternative embodiment of the device shown in FIG. 1.

FIG. 6b shows a schematic plan view of the alternative embodiment shown in FIG. 6a.

Like reference symbols in the various drawings indicate like elements.

### DETAILED DESCRIPTION

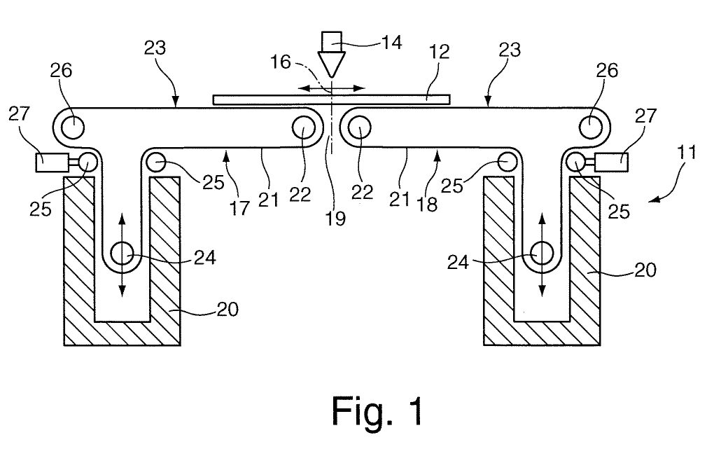

FIG. 1 illustrates a schematic side view of a device 11 according to the invention. Such a device 11 serves to support plate-shaped material 12 which is machined by a separating mechanism 14, of which only a separating or cutting head is illustrated by way of example. A beam/jet 16 is guided to the plate-shaped material 12 by the separating or cutting head of the separating mechanism 14. Said beam/jet 16 may be provided in the form of electromagnetic radiation, in particular in the form of a laser beam, a water jet or the like. The device 11 comprises two supporting tables 17, 18 between which a gap 19 is formed. The supporting tables 17, 18 each have a belt conveyor 21. The belt conveyors 21 are arranged separately from each other and each is guided and tensioned by a plurality of rollers 22, 24, 25, 26. Each belt conveyor defines a supporting surface 23 for the plate-shaped material 12, formed between two of the rollers 22, 26 which lie in a plane. The supporting tables 17, 18 may each be provided on a separate basic framework 20 (illustrated symbolically) or on a common basic framework (not shown).

During the processing of the plate-shaped material 12, the separating mechanism 14 is movable in the X direction (into the plane of the paper in FIG. 1) along the gap 19. Furthermore, the separating mechanism 14 is movable in or counter to an advancing direction of the plate-shaped material 12, which direction corresponds to the Y direction. An operating region of the separating mechanism 14 is determined by the maximum movement distance of the separating or cutting head in the X direction and in the Y direction if the separating mechanism 14 includes movability in the Y direction. In order to machine the plate-shaped material 12, it is provided that the gap 19 is positioned below the separating mechanism 14. During the machining of the plate-shaped material 12, the rollers 22 assigned to the gap 19 may preferably be moved synchronously in order to maintain the gap width within an operating region of the separating mechanism 14. In this case, the plate-shaped material 12 may remain positioned in a fixed position with respect to the first and second supporting tables 17, 18 or may be provided resting in the operating region. In addition, the movement of the plate-shaped material 12 in the Y direction may be combined by means of the driving of the belt conveyors 21.

As soon as the position of the gap 19 within the operating region is changed, the roller 22, which is assigned to the gap 19, migrates in a plane parallel to the supporting surface 23. The change in the size of the supporting surface 23 is compensated for by the roller 24 which may be moved up and down in the Z direction, for example as indicated by the arrows in FIG. 1. Roller 24 may be designed as a dancing roller or jockey roller in order to follow the movement of the roller 22.

The belt conveyor 21 is guided by means of at least one deflection pulley 25. At least one of the deflection pulleys 25 may be driven by a motor 27 in order to move the belt conveyor 21 in and counter to the advancing direction or Y direction.

In order to unload the plate-shaped material 12 which has been machined, the belt conveyors 21 may be driven such that the machined, plate-shaped material 12 is transported out of the operating region of the separating mechanism 14. Such an embodiment is illustrated by way of example in FIG. 2. The gap 19 remains within the operating region and, by means of the driving of the belt conveyors 21, the machined plate material 12 is deposited in a stack 28. Subsequently, an unmachined, plate-shaped material 12 may be supplied via a handling mechanism or, for example, a chute, with the belt conveyor 21 being driven in the Y direction in order to position the latter with respect to the gap 19 for the further machining steps. In the case of the embodiment illustrated in FIG. 2, the roller 26 remains in a rest (fixed) position during loading and unloading, and the loading and unloading take place via driven belt conveyors 21.

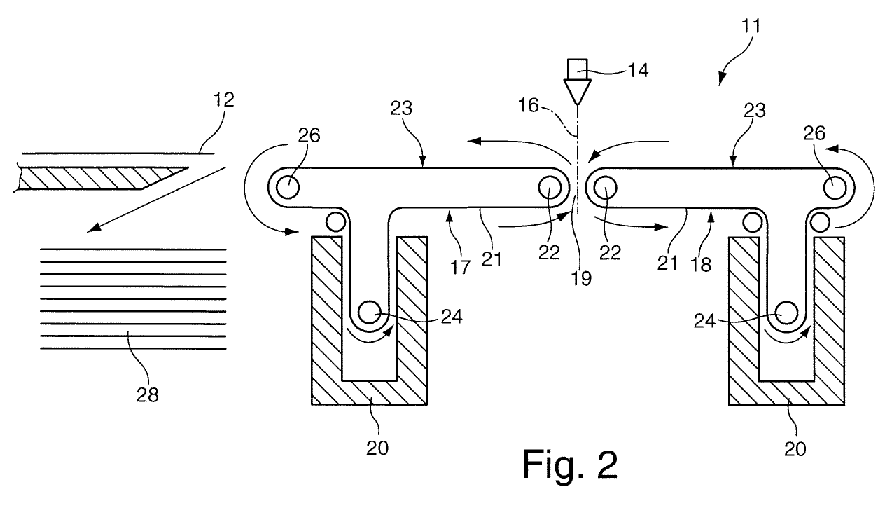

FIG. 3 illustrates an alternative procedure for loading and unloading the plate-shaped material 12. In this implementation, the rollers 22, 26 are both movable in a plane parallel to the supporting surface 23. This arrangement makes it possible for the machined, plate-shaped material 12 to be transported out of the operating region of the separating mechanism 14 and for the roller 26 which is located remote from the gap 19 to be moved into a loading and unloading position 31. In addition, the belt conveyor 21 may be driven in order to position the machined, plate-shaped material 12 in an outer position remote from the gap 19 for unloading purposes. In this unloading and loading position 31, handling systems such as, for example, a suction system 40, may lift the machined, plate-shaped material 12 from the supporting surface 23. The handling system may then be transferred into a position adjacent to the supporting surface 23 in order to deposit the machined, plate-shaped material 12, for example, in a stack 28. At the same time, a second handling system (not shown) may position an unmachined, plate-shaped material 12 on the supporting surface 23 of the supporting table 17, which supporting surface is arranged in the loading and unloading position 31.

As an alternative to said handling operation, the roller 26 lying remote from the gap 19 may initially be positioned relative to the stack 28 of machined, plate-shaped materials 12 so that the machined, plate-shaped material 12 can be unloaded by movement of the belt conveyor 21, without the need for a handling system. The roller 26 is subsequently transferred into the loading and unloading position 31 in order to deposit a new plate-shaped material 12 on the supporting surface 23 of the supporting table 17. At least one further stack containing plate-shaped material (not shown) may also be provided adjacent to the stack 28. Such stacks adjacent to each other may include unmachined plate-shaped materials with different geometries and/or of different materials and also machined, plate-shaped materials, which may be selectively delivered to the supporting surface 23.

The rollers 22, which are movable in the plane parallel to the supporting surface 23, make it possible for the supporting surface 23 and, if appropriate, for the gap 19 to be displaced, for the size of the supporting surface 23 to be changed and for the belt conveyor 21 to be driven, thus permitting great flexibility in the selection and configuration of the machining situations.

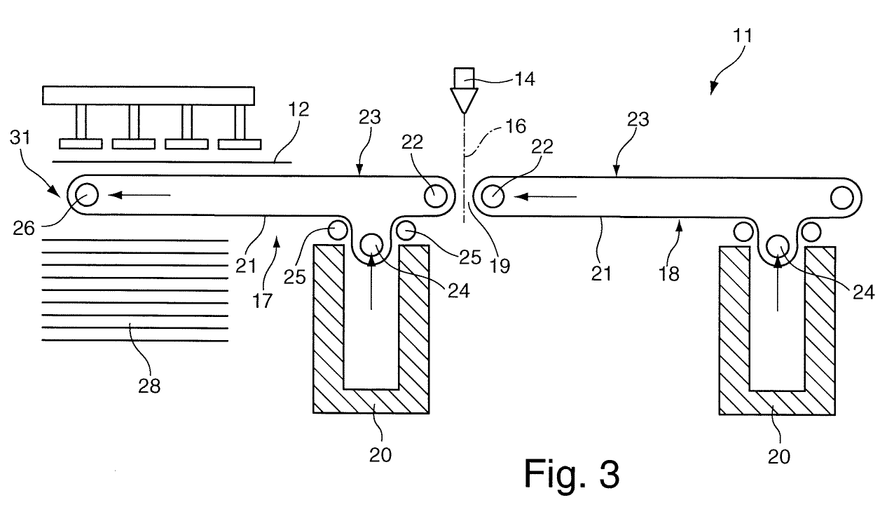

FIG. 4 illustrates an example of a machining situation in which machining of a plate-shaped material 12 located in the operating region of the separating mechanism 14 takes place during the loading of plate-shaped material 12 to be machined and the unloading of machined, plate-shaped material 12. By means of the rollers 22 which are assigned to the gap 19 and are movable in the Y direction below the separating mechanism 14, the material 12 to be machined remains at rest in the operating region and complete machining is made possible. The rollers 26 which are movable into a loading and unloading position 31 make it possible for the supporting surface 23 to be extended from the operating region of the separating mechanism 14 into a loading and unloading position 31 such that the plate-shaped material 12 may be removed from and deposited on the supporting tables 17, 18 by the device.

After the plate-shaped material 12 located in the operating region is machined, it is moved, for example by the belt conveyors 21 being driven in the advancing direction, to position 31 of table 18, for removal purposes. The plate-shaped material 12 which is placed onto the supporting table 17 passes into the operating region and is machined. That operating surface 23 of the operating table 17 that has become partially free as a result is refilled with a plate-shaped material to be machined. Continuous machining of the plate-shaped material 12 may therefore take place without shutdown periods for the separating mechanism 14.

In the case of this embodiment of the operating tables 17 and 18, the movable roller 24 is driven by a motor 27. The rollers 22 and 26 or all of the rollers may also be driven analogously by a motor. The motor 27 will be arranged as a function of the available construction space.

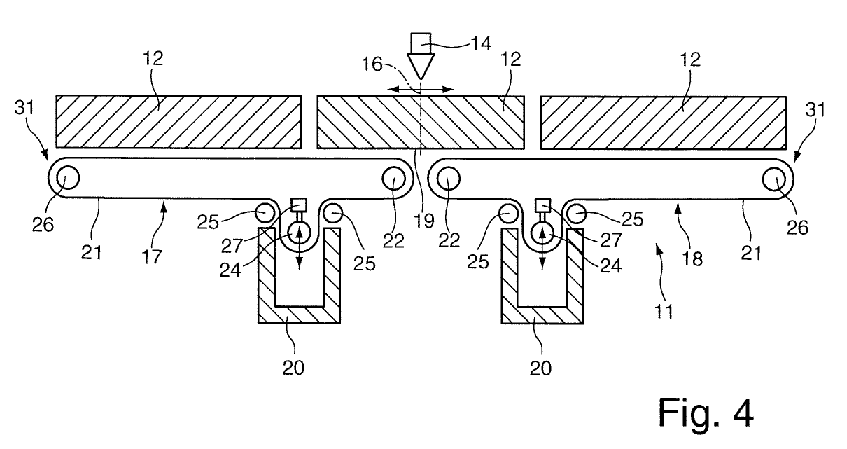

FIG. 5a illustrates, by way of example, an alternative configuration of a supporting table 17, 18. The rollers 22 and 26 are displaceable in the horizontal plane to set the size of the supporting surface 23, the positioning of surface 23 in an unloading and loading position 31, or to change the position of the gap 19 and/or the width of the gap 19. In the implementation shown in FIG. 5a, the rollers 24 are vertically movable relative to one another in order to compensate for the length of the belt conveyor 21 when changing the distance between the rollers 22 and 26.

FIG. 5b illustrates an alternative embodiment. For example, the rollers 24 may be movable parallel to the rollers 22 and 26 in order to maintain the tensioning of the belt conveyor.

In addition, a combining of the embodiments according to FIGS. 5a and 5b may also be provided.

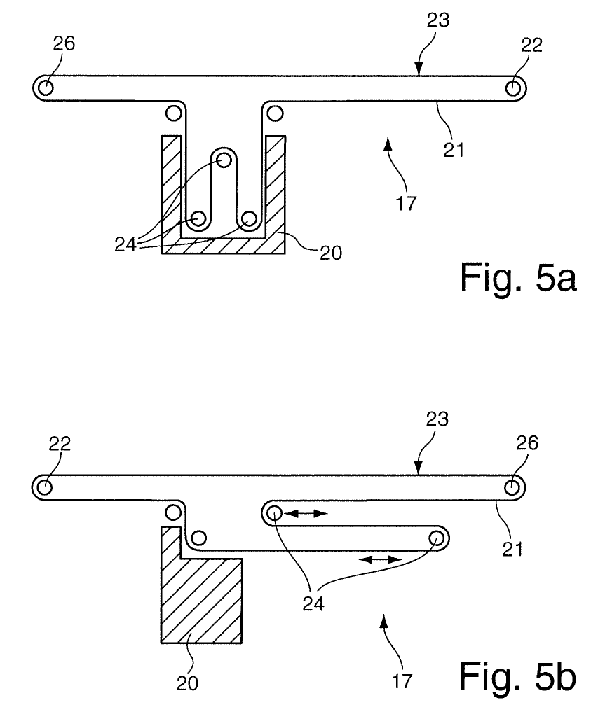

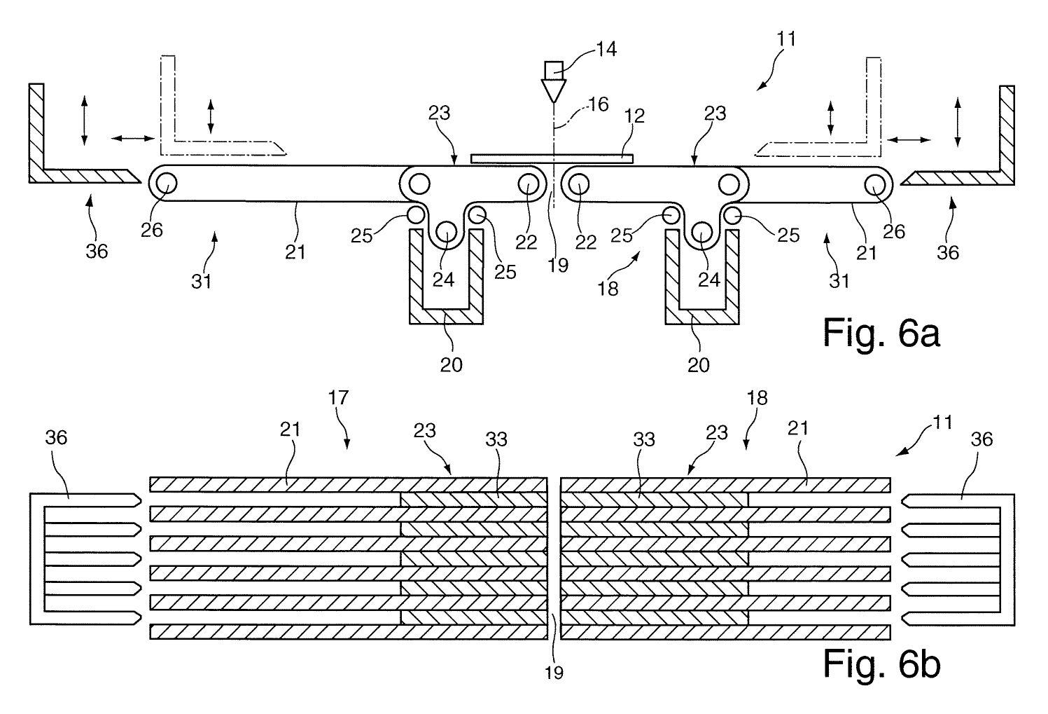

FIGS. 6a and 6b illustrate an alternative embodiment of the device 11. The supporting tables 17, 18 comprise a multiplicity of individual belt conveyors 21 and belt conveyors 33 which are arranged next to one another and the supporting surfaces 23 of which are designed such that they differ in size. A first group of belt conveyors 33 has, for example, a supporting surface 23 which extends at least within an operating region of the separating mechanism 14. A second group of belt conveyors 21 has a length of supporting surface 123 movable as far as a loading and unloading position 31. This makes it possible as a result to provide, between the individual belt conveyors 21, clearances 42 (FIG. 6b) through which the loading and unloading of the plate-shaped material 12 is made possible by means of a handling mechanism 36 of rake- or fork-shaped design. Said handling mechanism 36 of rake-shaped design may be positioned in the intermediate spaces between the individual belt conveyors 21 (i.e., clearances 42) in order to permit loading and unloading.

The rollers 26 of the belt conveyors 21 may be formed by a common axle or in each case by a separate axle. The rollers 22 assigned to the gap 19 are preferably held by a common axle such that the belt conveyors 21, 33, forming a shorter supporting surface 23 and a longer supporting surface 123 respectively, are deflected synchronously in the gap 19. The rollers 126 of the supporting surface 23, which is of shortened design, may be fixed in position or, alternatively, may be designed such that they may likewise be displaced in the plane parallel to the supporting surface 23.

A number of embodiments of the invention have been described. Nevertheless, it will be understood that various modifications may be made without departing from the spirit and scope of the invention. For example, the supporting devices described herein are not restricted to having only two supporting tables 17, 18 which are separated by a gap 19. On the contrary, a supporting device may include three or more supporting tables 17, 18, between the respective supporting surfaces of which gaps 19 are provided. Machining with a plurality of separating mechanisms 14 may therefore take place in one machining machine with a plurality of separating mechanisms 14, with at least one separating mechanism 14 being assigned to at least one gap 19. It may likewise be provided that a plurality of separating mechanisms 14 are assigned to a gap 19. The number of separating mechanisms 14 and the assignment thereof to one and/or more gaps 19 may take place as a function of the required machining capacity. Accordingly, other embodiments are within the scope of the following claims.

What is claimed is:

1. A device for supporting plate-shaped materials for at least one separating operation using a separating mechanism that is movable at least in the X direction during the separating operation, the device comprising:
a first supporting table having a first supporting surface, and
a second supporting table having a second supporting surface,
the supporting surface of the first supporting table and the supporting surface of the second supporting table being spaced apart from each other by a gap which is located below the separating mechanism,
each of the supporting tables comprising a separately driven belt conveyor which is guided by a plurality of rollers, each supporting surface being formed between at least two of the rollers which are spaced apart from each other and lie in a plane,
said at least two rollers being movable independently of each other in and counter to the Y direction.

2. The device as claimed in claim 1, characterized in that the belt conveyor is guided by at least three rollers, and at least one of the rollers which guides the belt conveyor, other than the at least two rollers that are spaced apart from each other and lie in a plane, is movable in one direction in space.

3. The device as claimed in claim 2, characterized in that the movable roller is movable in a Z direction.

4. The device as claimed in claim 2 characterized in that the movable roller is moveable in a Y direction.

5. The device as claimed in claim 1, characterized in that the at least one of the rollers of the first supporting table and at least one of the rollers of the second supporting table are assigned to the gap, and the rollers of each supporting table that are assigned to the gap are movable relative to each other in order to set a gap width.

6. The device as claimed in claim 1, characterized in that a position of the gap formed between the first and second supporting tables is set within an operating region of the separating mechanism.

7. The device as claimed in claim 5, characterized in that, at least for the loading or unloading of a plate-shaped material, at least one roller of the supporting surface of the first and second supporting tables, which roller lies opposite the at least one roller that is assigned to the gap, is movable into at least one loading or unloading position independently of the at least one roller that is assigned to the gap.

8. The device as claimed in claim 1, characterized in that the rollers assigned to the gap are movable so that, during the machining of the plate-shaped material, the gap is provided below the separating mechanism with the plate-shaped material resting in the operating region of the separating mechanism.

9. The device as claimed in claim 1, further comprising a drive configured to drive the belt conveyor in a rotating manner in or counter to the Y direction during the machining of the plate-shaped material.

10. The device as claimed in claim 1, characterized in that the first supporting table and the second supporting table each have a multiplicity of individual belt conveyors arranged parallel to one another.

11. The device as claimed in claim 9, characterized in that the individual belt conveyors of each supporting table are spaced apart from one another.

12. The device as claimed in claim 9, wherein the first supporting table and second supporting table each comprise a plurality of first belt conveyors located in between individual second belt conveyors, and said first belt conveyors define a supporting surface which extends at least within an operating region of the separating mechanism.

13. The device as claimed in claim 1, characterized in that one of the movable rollers of at least one of the first supporting table and the second supporting table is driven by a motor.

14. The device as claimed in claim 1, further comprising a deflection roller which is fixed in position with respect to at least one of the first supporting table and the second supporting table, which deflection roller is driven by a motor and drives the belt conveyor.

15. A method of supporting a plate-shaped material during at least one separating operation, using a separating mechanism that is movable at least in the X direction during a separating operation, the method comprising:
supporting the plate-shaped material on a supporting device comprising a first supporting table having a first supporting surface, and a second supporting table having a second supporting surface,
positioning the supporting surface of the first supporting table and the supporting surface of the second supporting table spaced apart from each other by a gap which is located below the separating mechanism,
providing each of the supporting tables with a separately driven belt conveyor which is guided by a plurality of rollers, each supporting surface being formed between at least two of the rollers which are spaced apart from each other and lie in a plane, the gap being defined between one of the rollers that form the first supporting surface and one of the rollers that form the second supporting surface, and
adjusting the position or width of the gap by moving at least one of the gap-defining rollers, which are movable independently of each other in and counter to the Y direction.

16. The method of claim 15 further comprising machining a portion of the plate-shaped material overlying the gap using the separating mechanism.

17. The method of claim 15 further comprising moving at least one of the gap-defining rollers, during the machining of the plate-shaped material with the plate-shaped material resting in the operating region of the separating mechanism, so that the gap is provided below the separating mechanism.

18. The method of claim 15 further comprising, at least for the loading or unloading of a plate-shaped material, moving at least one roller of the supporting surface of the first and second supporting tables, which roller lies opposite the at least one roller that is assigned to the gap, into at least one loading or unloading position independently of at least one of the rollers that is adjacent the gap.

19. A device for supporting plate-shaped materials for at least one separating operation using a separating mechanism that is movable at least in the X direction during the separating operation, the device comprising:
a first supporting table having a first supporting surface, and
a second supporting table having a second supporting surface,
the supporting surface of the first supporting table and the supporting surface of the second supporting table being spaced apart from each other by a gap which is located below the separating mechanism,
each of the supporting tables comprising a separately driven belt conveyor which is guided by a plurality of rollers, each supporting surface being formed between at least two of the rollers which are spaced apart from each other and lie in a plane,
said at least two rollers being movable independently of each other in and counter to the Y direction,
wherein at least one other of the rollers which guide the belt conveyor is a movable roller that is movable in a Z direction.

20. The device as claimed in claim 19, characterized in that the at least one of the rollers of the first supporting table and at least one of the rollers of the second supporting table are assigned to the gap, and the rollers of each supporting table that are assigned to the gap are movable relative to each other in order to set a gap width.
